(19) United States
(12) Patent Application Publication
(10) Pub. No.: US 2025/0212297 A1
(43) Pub. Date: Jun. 26, 2025

(54) INDUCTION COOKING HOB

(71) Applicant: ELECTROLUX APPLIANCES AKTIEBOLAG, Stockholm (SE)

(72) Inventors: Alex VIROLI, Forli (IT); Massimo NOSTRO, Forli (IT); Fabio ANGELI, Forli (IT); Filippo MARTINI, Forli (IT)

(21) Appl. No.: 18/849,049

(22) PCT Filed: Mar. 3, 2023
(86) PCT No.: PCT/EP2023/055503

§ 371 Date: Sep. 20, 2024

(30) Foreign Application Priority Data
Mar. 25, 2022 (EP) 22164529.4

(51) Int. Cl. H05B 6/06; H05B 6/12

(52) U.S. Cl. CPC H05B 6/065; H05B 6/1209; H05B 2213/05

(57) ABSTRACT

An induction cooking hob has a support surface for carrying a load on a cooking zone, a plurality of induction coils, a load detection unit configured to sense a presence of the load in the vicinity of one or more induction coils and a control and power unit configured to selectively power the one or more induction coils. The load detection unit is configured to sense by means of the induction coils a movement of the load away from the cooking zone and to send a start signal about the movement to the control and power unit. The control and power unit is configured to determine a command signal in dependence of the start signal about the movement and to execute the command signal and to continue to selectively power the one or more induction coils so as to maintain the cooking zone unvaried.

The present invention relates to an induction cooking hob for the thermal treatment of food products.

Induction cooking hobs for the thermal treatment of food products are known household devices, which are conveniently efficient if compared with traditional gas or electric cooking appliances, because on the one side, they are accurate in controlling a cooking temperature and, on the other side, allow an uniform thermal treatment of the food product.

Induction cooking hobs typically comprise: a support plate provided with one or more cooking zones designed to heat loads, i.e. cooking vessels containing the food product, placed on the support plate. Each cooking zone comprises at least one induction coil for generating a time-varying electro-magnetic field inducing eddy currents in the loads.

There are also known cooking hobs, which comprise a plurality of induction coils whereby the cooking zones can be dynamically defined in dependence of the position on the support surface on which the user has placed the load.

In the recent years, a desire has increased in improving more and more the cooking experience and to facilitate the cooking activities.

A need is felt in the sector to improve the known induction cooking hobs, in particular so as to further increase the cooking experience of the users.

According to the present invention, there is provided an induction cooking hob and a method of operating a cooking hob according to the respective independent claims.

Preferred non-limiting embodiments are claimed in the claims directly or indirectly depending on the independent claims.

In addition, according to the present invention, there is provided an induction cooking hob, for the thermal treatment of food products comprising at least. The induction cooking hob comprises:
a support surface for carrying a load on a cooking zone, the load holding the food product;
a plurality of induction coils arranged below the support surface, wherein one or more induction coils are associated to the cooking zone;
a load detection unit operatively connected to the plurality of induction coils configured to sense by means of the induction coils a presence of the load in the vicinity of one or more induction coils; and
a control and power unit operatively connected to the plurality of induction coils and configured to selectively power the one or more induction coils so as to selectively generate an electromagnetic field for heating the load on the cooking zone;
wherein the load detection unit is configured to sense by means of the induction coils a movement of the load away from the cooking zone and to send a start signal about the movement of the load away from the cooking zone to the control and power unit;
wherein the control and power unit is configured determine a command signal in dependence of the start signal about the movement of the load away from the cooking zone and to execute the command signal; and
wherein the control and power unit is furthermore configured to continue to selectively power the one or more induction coils so as to maintain the cooking zone unvaried.

In this way, the induction cooking hob can be controlled by the user without the need to manipulate control buttons or the like of a user interface of the induction cooking hob, thereby improving the user experience. All this is achieved without the need of extra sensors as the load detection unit relies on the already present induction coils.

It should be stressed that cooking zone is not varied as a result of the movement, but remains unvaried (i.e. constant) for the specific cooking operation.

Additionally, the load is “in the vicinity” of an induction coil if the induction coil is able to sense and/or interact with the load by means of a respective electromagnetic field.

Moreover, the one or more induction coils associated to the cooking zone are the one or more induction coils effectively used to interact with the load for generating eddy currents within the load.

Preferentially, the load may be a cooking vessel such as a pan, pot or kettles, carrying the food product to be thermally treated.

The load may be adapted to be heated by means of induction heating and in particular, may comprise and/or substantially consist of a magnetic and/or ferromagnetic material.

The load may be of any kind and/or may have any kind of form.

The load may also comprise a lid or is void of a lid.

The food product to be thermally treated may be a single ingredient or a mixture of ingredients. It should also be noted that the food product to be treated may vary throughout the overall thermal treatment process; i.e. it may be possible to add or remove ingredients to the food product during the thermal treatment.

Preferentially, the load detection unit may be operatively connected to the control and power unit.

According to some preferred non-limiting embodiments, the load detection unit may also be configured to sense by means of the induction coils a second movement of the load back to the unvaried cooking zone and to send an end signal to the control and power unit. The control and power unit may be configured to define the command signal in dependence of the start signal and the end signal.

In this way, it is possible to precisely define the command signal in these cases, when the user shall have the option to device between varying options.

Preferentially, but not necessarily the control and power unit may be configured to determine the command signal in dependence of the time between moving the load away and back from the unvaried cooking zone and/or the time between the start signal and the end signal.

In this way, it is possible to provide to the user varying options such that the command signal corresponds to the desired one and without the need to move the load away and back several times.

Preferentially but not necessarily, the control and power unit may be configured to modify a desired command, in particular defining a desired cooking parameter, associated to the command signal according to a predetermined scheme after receiving the start signal and to end modification of the desired command after receiving the end signal so as to obtain a finalized desired command. The command signal may be indicative about the finalized command, in particular the finalized command defining a new cooking parameter and the control and power unit is configured to control the one or more induction coils according to the new cooking parameter.

The predetermined scheme allows to give the user a variety of options between the user can choose. Thus, once the predetermined scheme has arrived at the command of interest, the user puts back the load onto the cooking zone, which is easy and efficient as avoiding to repeatedly move the load until having the command of interest.

Preferentially but not necessarily, the command may be indicative about a cooking parameter and the finalized command defines the new cooking parameter. The control and power unit may be configured to control the one or more induction coils associated to the cooking zone in dependence of the new cooking parameter.

In this way, it is possible to set a new cooking parameter with the need to push any control buttons or the like, significantly improving the cooking experience.

Preferentially but not necessarily, the predetermined scheme comprises a step width and the control and power unit is configured to modify the desired cooking parameter as a function of the step width and between the time of receiving the start signal and the end signal. In particular, the control and power unit is configured to control the one or more induction coils associated to the cooking zone in dependence of the new cooking parameter.

This allows to easily set the desired new cooking parameter.

Preferentially but not necessarily, the cooking parameter may be chosen from a desired power level, a cooking time or a desired cooking temperature of the load and/or the food product.

According to some preferred embodiment, the induction cooking hob further comprises an user interface configured to allow for setting the step width and/or the predetermined scheme.

In this way, it is possible for the user to adopt to the specific personal preferences and requirements. It is e.g. also possible to define larger or smaller step widths possibly also considering the personal preferences related to the specific cooking programs the user typically relies on. E.g. the user may need to be able to quickly reduce or increase a cooking temperature, which may be advantageously achieved by means of a larger step width. The user also obtains the possibility to set the step width and/or the predetermined scheme prior to starting the cooking process.

According to some preferred non-limiting embodiments, the load detection unit may be configured to detect by means of the induction coils a direction of the movement of the load away from the unvaried cooking zone. The command signal is dependent on the direction of the movement.

In this way, one may obtain different command signals in dependence of the direction of the movement. E.g. it may be possible that movement into one direction increases e.g. a cooking parameter, while movement into the opposite direction reduces the cooking parameter. Or according to another embodiment, movement into one direction approves an action suggested by the induction cooking hob, while movement into the opposite direction disapproves the action.

According to some preferred non-limiting embodiments, the induction cooking hob may further comprise an user interface configured to allow for setting a type of the command signal.

In this way, the user may set his preferences with regard to the type of the command signal, thereby further improving the cooking experience. E.g. the user may define the preference to modify a cooking time or a cooking temperature or a power level.

Additionally or alternatively, the user may define on the command signal being indicative about an approval or disapproval.

According to some non-limiting embodiments, the induction cooking hob may further comprise a display unit configured to indicate an information associated to the command signal. In this way, the user is informed about the command signal. The information may also be directed to the command signal which would be executed if the user places the load back onto the cooking zone.

According to some non-limiting embodiments, the induction cooking hob may also comprise a voice control user interface configured to communicate to the user an action to be taken by the induction cooking hob. The command signal may be indicative about an approval or disapproval of the action to be taken by the induction cooking hob. The control and power unit may be configured to control an execution of the action communicated to the user by the voice control user interface in dependence of the approval or disapproval of the action.

In addition or alternatively, the induction cooking hob may comprise a display unit configured to display an action to be taken by the induction cooking hob. The command signal may be indicative about an approval or disapproval of the action to be taken by the induction cooking hob visually communicated to the user by means of the display unit. The control and power unit may be configured to control an execution of the action visually communicated to the user by the display unit in dependence of the approval or disapproval of the action.

In this way, one achieves a further improvement of the cooking experience. A proposed action may be executed only after an approval and without the need to manipulate any control buttons. This may also be advantageous, when the induction cooking hob executes an automatic cooking program and a new action, e.g. increasing the power level, may be required. Accordingly, one also increases the safety of operation of the induction cooking hob.

In addition, according to the present invention, there is provided a method of operating an induction cooking hob. The method comprises the steps of:
powering the one or more induction coils associated to the cooking zone;
moving the load away from the cooking zone;
sensing by means of the induction coils the movement of the load away from the cooking zone;
sending a start signal about the movement of the load away from the cooking zone to the control and power unit;
executing by means of the control and power unit a command signal determined, in particular determined by the control and power unit itself, in dependence of the start signal about the movement of the load away from the cooking zone; and
newly placing the load onto the cooking zone.

In this way, one improves the cooking experience as the user does not need to operate any control buttons. Additionally, the structure of the induction cooking hob is void of any additional sensors. Thus, even though the cooking experience has improved, the induction cooking hob has not become more complex.

According to some preferred non-limiting embodiments, the method may furthermore comprise the steps of detecting, during which a second movement of the load back to the cooking zone is detected and sending an end signal to the control and power unit. During the step of executing, the control and power unit may execute the command signal, which is determined in dependence of the start signal and the end signal.

In this way, one can control the command signal so as to obtain a desired action of the induction cooking hob without the need to repeatedly move the load away from and back to the cooking zone. The user only needs to wait for the required time such that placement of the load back onto the cooking zone results in the desired command signal and the desired action of the induction cooking hob.

Preferentially but not necessarily, the method may further comprise a step of adjusting, during which the control and power unit determines the command signal in dependence of the time between moving the load away and back from the unvaried cooking zone and/or the time between the start signal and the end signal.

Preferentially but not necessarily, during the step of adjusting, the control and power unit may modify a desired command, in particular defining a respective cooking parameter, associated to the command signal according to a predetermined scheme after receiving the start signal and to end modification of the desired command after receiving the end signal so as to obtain a finalized desired command. During the step of executing, the command signal executed by the control and power unit is indicative about the finalized command, in particular the finalized command being indicative about a new cooking parameter and the control and power unit controls the one or more induction coils associated to the cooking zone according to the new cooking parameter.

In this way, it is not necessary to repeatedly move the load for obtaining the desired finalized command.

Preferentially but not necessarily, the command is indicative about a cooking parameter and the finalized command defines the new cooking parameter. During the step of executing, the control and power unit controls the one or more induction coils associated to the cooking zone in dependence of the new cooking parameter.

In this way, one easily obtains the desired cooking performance of the induction cooking hob.

Preferentially but not necessarily, the predetermined scheme may comprise a step width with which the desired cooking parameter is modified between the time of receiving the start signal and the end signal.

This allows to easily set the desired cooking parameter to be applied.

Preferentially but not necessarily, the cooking parameter is chosen from a desired power level, a cooking time or a desired cooking temperature of the load and/or the food product.

According to some preferred non-limiting embodiments, the induction cooking hob further comprises an user interface configured to allow for setting the step width and/or the predetermined scheme. The method further comprises a step of setting, during which the step width and/or the predetermined scheme is set through the user interface.

This allows to personalize the operation of the induction cooking hob, which is also possible prior to a cooking process.

According to some preferred non-limiting embodiments, during the step of detecting, a direction of the movement of the load away from the unvaried cooking zone may be detected. The command signal may be dependent on the direction of the movement.

In this way, it is possible to easily obtain different command signals. It may e.g. be possible to increase or decrease a cooking parameter or to approve or disapprove an action of the induction cooking hob in dependence of the direction of the movement of the load.

According to some preferred non-limiting embodiments, the method may also comprise a step of setting a type of the command signal, during which the type of the command signal is set. In particular, the type of the command signal may be set by the user interface and/or the voice control user interface.

This allows to personalize the operation of the induction cooking hob.

According to some preferred non-limiting embodiments, the method may also comprise a step of indicating, during which a display unit of the induction cooking hob may indicate an information associated to the command signal.

In this way, the user is facilitated in understanding on whether the desired action will be obtained after moving the load back onto the cooking zone.

According to some preferred non-limiting embodiments, the method may also comprise a step of approving or disapproving, during which the command signal may be indicative about an approval or disapproval of an action to be taken by the induction cooking hob and as communicated to the user by means of a voice control user interface and/or a display unit of the induction cooking hob.

Such a solution improves the control of the operation of the induction cooking hob.

A non-limiting embodiment of the present invention will now be described, by way of example, with reference to the accompanying drawings, in which:

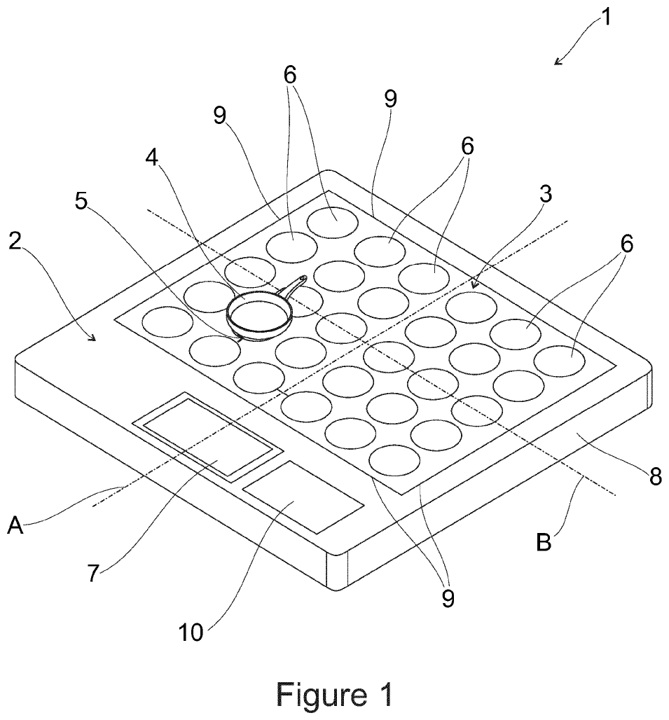

FIG. 1 is a schematic sketch of an induction cooking hob according to the present invention, with parts removed for clarity;

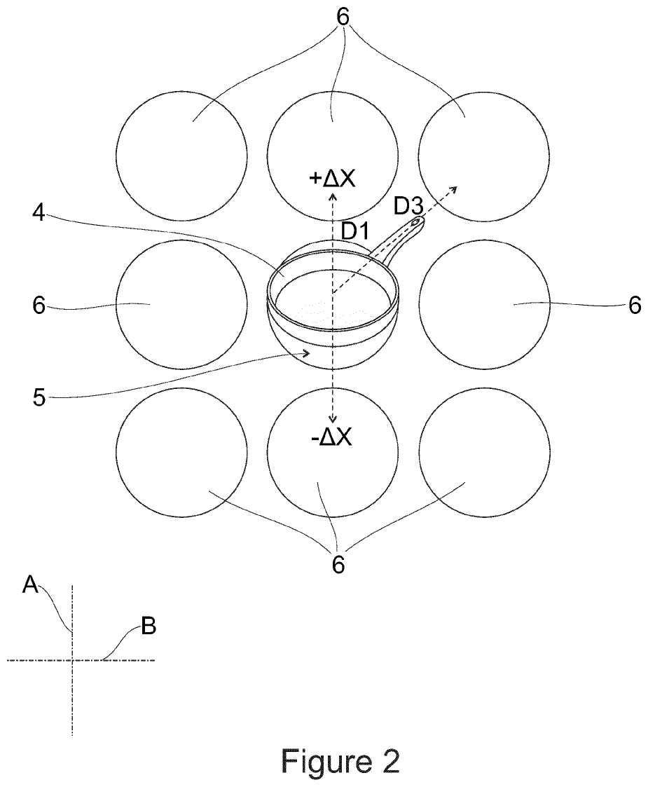

FIG. 2 is a schematic sketch of a portion of the induction cooking hob of FIG. 1 according to a first option of operation, with parts removed for clarity;

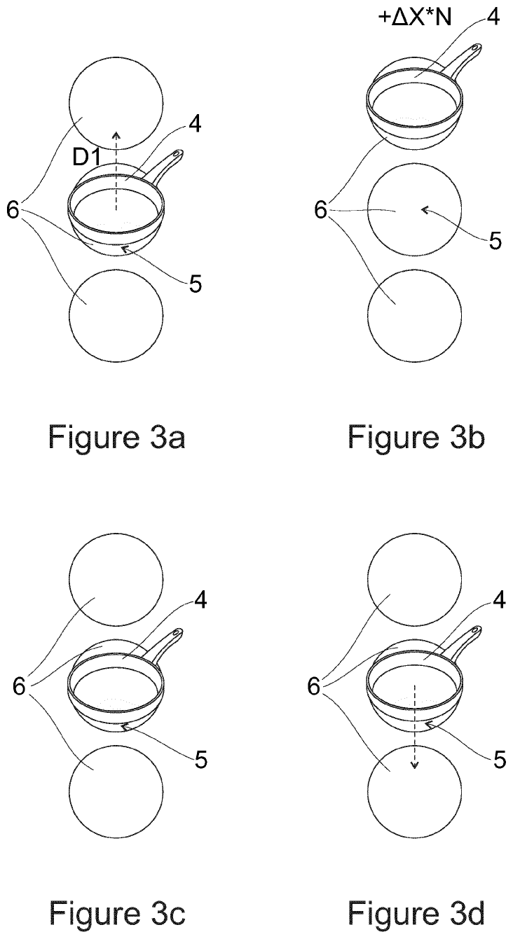

FIG. 3 is a schematic sketch of an operation of the induction cooking hob of FIG. 1, with parts removed for clarity;

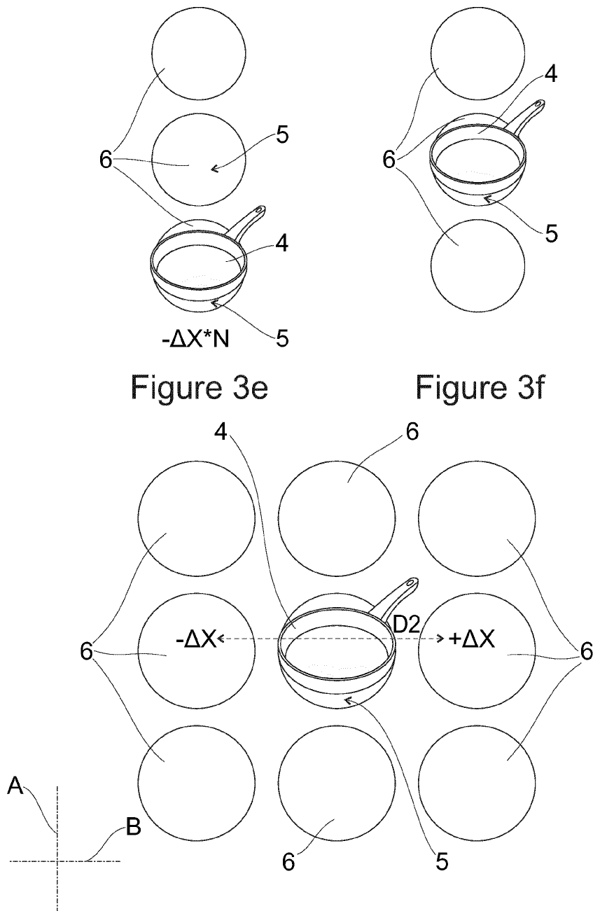

FIG. 4 is a schematic sketch of the induction cooking hob of FIG. 1 according to a second option of operation; and

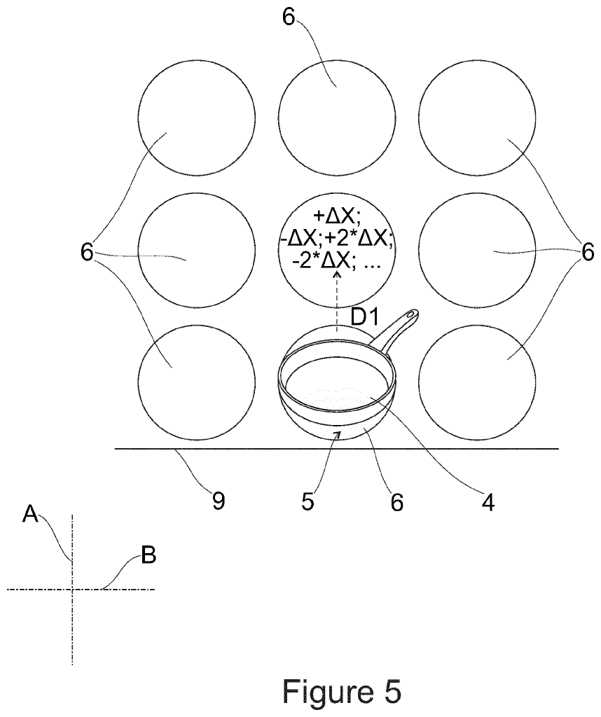

FIG. 5 is a schematic sketch of the induction cooking hob of FIG. 1 according to a third option of operation.

With particular reference to FIG. 1, number 1 indicates as a whole an induction cooking hob, for the thermal treatment, in particular for the heating and/or cooking, of food products.

The food product to be thermally treated may be a single ingredient or a mixture of ingredients. It should also be noted that the food product to be treated may vary throughout the overall thermal treatment process; i.e. it may be possible to add or remove ingredients to the food product during the thermal treatment.

Induction cooking hob 1 comprises:
a hob panel 2 having a support surface 3 for carrying a load 4 on a cooking zone 5 (of induction cooking hob 1) and load 4 holds the food product;
a plurality of induction coils 6 arranged below support surface 3 and each one configured to generate a respective (time-varying) electromagnetic field; and
a control and power unit operatively connected to induction coils 6 and configured to selectively control, in particular power, induction coils 6.

More specifically, load 4 may be a cooking vessel such as a pan, pot or kettle. Even more specifically, load 4 may be adapted to be heated by means of induction heating and in particular, may comprise and/or substantially consist of) a magnetic and/or ferromagnetic material.

Load 4 may be of any kind and/or may have any kind of form. Load 4 may be provided with a lid or not.

One or more induction coils 6 are associated to cooking zone 5 and may be controlled by the control and power unit so as to heat load 4 placed on cooking zone 5. In particular, the control and power unit may be configured to selectively control the respective induction coils 6 so as to generate a desired electromagnetic field for interacting with load 4, in particular such that the occurring eddy currents heat load 4, even more particular in the desired manner.

In more detail, the control and power unit may be configured to selectively control the one or more induction coils 6 associated to cooking zone 5 according to one or more cooking parameters, such as the power level, a cooking time or a cooking temperature.

According to some possible non-limiting embodiments, the control and power unit may also be configured to control the one or more induction coils 6 according to a cooking program.

It should be noted that in the specific example shown in FIG. 1, only one load 4 is placed on support surface 3. It must, however, be understood that more than one load 4 may be placed on support surface 3, each on being placed on a respective cooking zone 5. Then, each one of loads 4 may be selectively heated through control of the respective one or more induction coils 6 associated to the respective cooking zone 5 by means of the control and power unit.

With reference to the examples of FIGS. 1 to 5, only one induction coil 6 is associated to each cooking zone 5. However, according to non-shown embodiments, also more than one induction coil 6 may be associated to each cooking zone 5.

Each cooking zone 5 may be static or dynamic. E.g. a static cooking zone 5 is a cooking zone 5, which has its specific and unvaried location on support surface 3 and has specific and unvaried induction coils 6 associated to it. A dynamic cooking zone 5 may vary, in particular may be defined in dependence of the initial (first) placement of the respective load 4 on support surface 3. Additionally, the dynamic cooking zone 5 may have also a varying number of induction coils 6 associated to it and also the specific induction coils 6 associated to it may vary.

Induction cooking hob 1 also comprises a load detection unit operatively connected to induction coils 6 so as to sense by means of induction coils 6 load 4 in the vicinity of one or more induction coils 6.

In particular, the load detection unit is configured to sense by means of induction coils 6 a movement of load 4 away from, and in particular also back to, cooking zone 5.

Additionally, the load detection unit may also allow to determine these induction coils 6 (one or more), which can be used for heating the respective load 4 being placed on the respective cooking zone 5.

Moreover and according to some possible non-limiting embodiments, the load detection unit may also be configured to determine cooking zone 5.

The load detection unit is operatively connected to the control and power unit, in particular such to communicate uni- or bi-directionally with the control and power unit.

E.g. in the non-limiting example of FIG. 1, the load detection unit detects that load 4 is arranged above only one respective induction coil 6 and the control and power unit powers the respective induction coil 6 for heating load 4.

Induction cooking hob 1 is configured such that a movement, in particular a temporary movement, of load 4 away from cooking zone 5 triggers the generation of an event. Such an event may e.g. be a modification of a cooking parameter or the approval or disapproval of an action to be taken by induction cooking hob 1.

Therefore, the load detection unit is configured to sense the movement of load 4 away from cooking zone 5 and to send, in particular to generate and send, a start signal about the movement of load 4 away from cooking zone 5 to the control and power unit.

The control and power unit is configured to determine a command signal in dependence of the start signal about the movement of the load 4 away from cooking zone 5 and to execute the command signal.

The command signal may e.g. be indicative about a cooking parameter to be modified. Such a cooking parameter may be a desired power level, a cooking time or a desired cooking temperature of load 4 and/or the food product placed within load 4.

Alternatively, the command signal may also be indicative about approving or disapproving the execution of an action to be taken by induction cooking hob 1.

It is important to note that the control and power unit is furthermore configured to continue to selectively power the one or more induction coils 6 associated to cooking zone 5 so as to maintain cooking zone 5 unvaried. This means that the movement of load 4 away from cooking zone 5 does not lead to a modification of the position of cooking zone 5 on support surface 3, but in particular solely triggers the generation of the command signal. Thus, in order to continue the cooking process, a user needs to newly place load 4 on cooking zone 5.

Such a mechanism, however, does not mean that induction cooking hob 1 cannot be of the dynamic type; i.e. that cooking zone 5 may be defined in dependence of the initial placement of load 4 on a specific position of support surface 3. However, once load 4 has been placed for the first time on support surface 3 cooking zone 5 is defined and defines a reference position for the generation of the command signal.

Preferentially, the load detection unit may also be configured to sense by means of induction coils 6 a second movement of load 4 back to cooking zone 5 maintained unvaried and to send an end signal to the control and power unit.

Preferentially, the control and power unit may be configured to determine the command signal in dependence of the start signal and the end signal, in particular in dependence of a time difference between the start signal and the end signal (i.e. the time between moving load 4 away and back from and to cooking zone 5).

In more detail, the load detection unit is configured such to sense movement of load 4 by means of induction coils 6, in particular the ones, which are associated to cooking zone 5, and/or the ones, which are adjacent to cooking zone 5.

In more detail, the load detection unit may be configured to determine respective impedance changes associated to induction coils 6 for sensing a movement of load 4.

In particular, the load detection unit may be configured to apply respective excitation signals, such as e.g. rectangular excitation signals, onto each induction coil 6 and to determine a resulting respective impedance associated to the respective induction coil 6. The respective impedance associated to each induction coil 6 is a function of the presence or absence of load 4.

In more detail and with particular reference to FIG. 1, hob panel 2 and/or support surface 3 may extend along a first axis A and a second axis B perpendicular to first axis A.

Preferentially, the load detection unit may be configured to sense a linear movement of load 4 for generating and sending the start signal, in particular the start signal or the end signal in dependence on whether the movement is away from or onto cooking zone 5.

The linear movement may be:
in a first direction D1 parallel to first axis A; and/or
in a second direction D2 parallel to second axis A; and/or
a third direction D3 parallel to an axis transversal to first axis A and second axis B.

According to some possible embodiments, the load detection unit may also be configured to detect the direction of the movement away from cooking zone 5.

FIG. 2 shows the example that a movement of load 4 along first direction D1 or a direction opposed to first direction D1 results into the generation of the start signal, while FIG. 4 illustrates the example of the generation of the start signal in dependence of a movement along second direction D2 or a direction opposed to second direction D2.

According to some possible non-limiting embodiments, the load detection unit may be configured such to detect movement only along one or two defined directions such that movement of load 4 along the defined direction(s) may result in the generation of the start signal. In particular, the two directions could be opposed to one another. Moreover, movement of load 4 into a direction different from the two defined directions would not result in the generation and sending of the start signal and/or the execution of an action by means of the control and power unit.

According to other non-limiting embodiments, the kind of command signal may be defined in dependence of the specific direction of the linear movement.

E.g. movement along first direction D1 may result in a modification of a cooking parameter and movement along second direction D2 may result in approving or disapproving an action to be executed.

Alternatively, it could also be possible that movement along first direction D1 may result in a modification of a first cooking parameter and movement along second direction D2 may result in modification of a second cooking parameter different from the first cooking parameter.

Induction cooking hob 1 may also comprise an user interface 7 configured to allow a user to control and/or communicate with induction cooking hob 1.

User interface 7 may be operatively connected to the control and power unit, e.g. for setting control instructions of the control and power unit. E.g. user interface 7 could be used to set cooking parameters.

User interface 7 may be incorporated into a housing 8 of induction cooking hob 1. Housing 8 may carry hob panel 2.

In addition or alternatively, user interface 7 may also comprise a remote control device, such as a smartphone, tablet or the like, and/or a unit configured to communicate with the remote control device.

In addition or alternatively to user interface 7, induction cooking hob 1 may also comprise a voice control user interface configured to interact with an user by means of audio signals. The voice control user interface may be configured to receive audio commands from the user and/or to output audio signals to the user.

E.g. the voice control user interface may also output audio signals indicative about an action, which shall be executed by induction cooking hob 1. E.g. such an action may be driven by an automatic cooking program, which is executed by induction cooking hob 1. Another example may be that the user communicates with the voice control user interface so as to modify a cooking parameter and the voice control user interface repeats the received instruction.

According to possible embodiments, it may be possible that movement of load 4 away from cooking zone 5 can be used to approve or disapprove the action proposed by the voice control user interface. In other words, the command signal may be indicative about an approval or disapproval of the action communicated to the user by means of the voice control user interface. The action may e.g. triggered by an automatic cooking program and/or an instruction received by the user and the need to receive confirmation of the instruction.

E.g. movement of load 4 away from cooking zone and into one defined direction, e.g. first direction D1 or second direction D2 or third direction D3, may approve the action and movement into an opposite direction may disapprove the action.

It may also be possible that movement of load 4 away from cooking zone 5 may approve the action and leaving load 4 onto cooking zone 5 without any movement, may disapprove the action.

The latter solution may be particular advantageous in these cases in which cooking zone 5 is arranged at an edge portion 9 of support surface 3 (see e.g. FIG. 5).

Support surface 3 may comprise a plurality of edge portions 9, four in the example shown. In particular, support surface 3 may be defined by a respective portion of hob panel 2 under which induction coils 6 are arranged. Therefore, movement of load 4 into at least one specific direction, would lead to load 4 leaving support surface 3. E.g. with reference to FIG. 5, one notes that movement into a direction parallel to axis A and away from, in particular a center, of support surface 3 would result in load 4 being distanced from induction coils 6.

According to some possible embodiments, user interface 7 and/or the voice control user interface may be configured to allow for setting a type of the command signal. E.g. the user may be allowed to set that the command signal may be indicative of a change of a defined cooking parameter or to allow approving or disapproving actions.

It may also be possible that the control and power unit is configured to adapt the command signal automatically. E.g. in the case that the voice control user interface may inform the user by means of an audio signal about an action to be taken by induction cooking hob 1, the control and power unit may automatically define a command signal indicative about the approval or disapproval of the action proposed.

According to some possible non-limiting embodiments, induction cooking hob 1 may also comprise a display unit 10.

Display unit 10 may be configured to display information about cooking zone 5 (such as a position of cooking zone 5 on support surface 3) and/or to indicate information associated to the command signal and/or to indicate an action to be executed by induction cooking hob 1.

In particular, in the case of display unit 10, in use, indicating an action to be executed by induction cooking hob 1, the command signal may be indicative about approval or disapproval of the action. E.g. movement of load 4 into one determined direction may approve the command signal, while movement into a direction opposed to the determined direction and/or no movement at all may disapprove the command signal.

According to some possible embodiments, the control and power unit may be configured setting and/or modifying a command associated to the command signal according to a predetermined scheme after receiving the start signal and to end modification of the command after receiving the end signal, the latter command determines the finalized command, which again determines the command signal, in particular such that the control and power unit executes the respective action associated o the command signal.

E.g. according to some possible non-limiting embodiments, the command could express “approval” or “disapproval”. Then after receiving the start signal (i.e. after movement of load 4) the scheme could foresee that the command starts to switch between “approval” and “disapproval”, until receipt of the end signal (i.e. after movement of load 4 back to cooking zone 5). Afterwards, in case of an approval, the control and power unit executes the approved action. In the case a disapproval, the control and power unit does not actuate any additional action.

According to some additional or alternative non-limiting embodiments, the command could express a desired cooking parameter, such as the desired cooking time, the desired cooking level and/or the desired cooking temperature. In particular, the command may be indicative about the new cooking parameter to be set and the finalized command defines the new cooking parameter. Accordingly, also the command signal defines the new cooking parameter.

Moreover, the control and power unit may be configured to control the one or more induction coils 6 associated to cooking zone 5 in dependence of the new cooking parameter.

Preferentially, the predetermined scheme may comprise a step width ΔX and the control and power unit may be configured to modify the desired cooking parameter between the time of receiving the start signal and the end signal.

Additionally, the predetermined scheme may comprise instructions on how to apply the step width ΔX. In other words, the control and power unit may be configured to modify the desired command, in particular the considered cooking parameter, as a function of the step width ΔX and the instructions.

E.g. a multiple of the step width (N*ΔX, with N being a natural number larger or equal to 1) may be added and/or subtracted to the presently active cooking parameter. Thereby, N may be modified according to a defined scheme and starting from the time of receiving the start signal and ending with the time or receiving the end signal. E.g. when reverting to FIGS. 3a to 3f one notes that movement of load 4 from the cooking zone 5 (see FIG. 3a) into the first direction D1 may initiate to virtually increase the cooking parameter from the presently active cooking parameter in steps of ΔX (see FIG. 3b) until the load 4 is moved back to cooking zone 5 (see FIG. 3c). Virtually increasing means that the cooking parameter will not be updated until load 4 is moved back to cooking zone 5 and the increasing of the cooking parameter occurs only with the scope to determine the finalized cooking parameter to be transmitted to the control and power unit after receipt of the end signal.

Additionally, moving load 4 from cooking zone 5 (see FIG. 3d) into a direction opposed to first direction D1, may initiate to virtually decrease the cooking parameter from the presently active cooking parameter in steps of ΔX (see FIG. 3e) until load 4 is moved back to cooking zone 5 (see FIG. 3f). In this way, the user can modify the cooking parameter during the cooking process without the need to rely on user interface 7.

In particular, the factor N may be increased in dependence of predetermined time steps and during the time between the start signal and the end signal.

It is clear that the user may also increase or decrease several times, the cooking parameter.

The same may also apply to movement into second direction D2 or movement into a direction opposed to second direction D2 as shown in FIG. 4.

When reverting to FIG. 5, one notes that when load 4 is placed at an edge portion 9, movement of load 4 is possible e.g. in first direction D1, but not into the opposed direction. According to such a case, the instructions may foresee to virtually alternate the updating of the cooking parameter. Thus, the cooking parameter will be virtually modified such that at first the presently active cooking parameter is virtually increased by ΔX, then it is virtually decreased by ΔX, followed by virtually increasing by 2*ΔX, virtually decreasing by −2*ΔX, and so on. Thus, the instructions may lead to the following scheme: X+ΔX; X−ΔX; X+2*ΔX; X−2*ΔX; X+3*ΔX; X−3*ΔX; . . . .

While the definition of such a scheme is particular advantageous when load 4 is arranged at an edge portion 9, it could also be applied in other zones of induction cooking hob 1, e.g. such that movement of load 4 into first direction D1 may induce modification of a first cooking parameter, movement of load 4 into a direction opposed to first direction D1 may induce modification of a second cooking parameter, movement of load 4 into second direction D2 may induce modification of a third cooking parameter and movement of load 4 into a direction opposed to second direction D2 may allow to approve or disapprove a command to be executed.

According to some preferred non-limiting embodiments, display unit 10 may be configured to indicate the command, e.g. the virtually modified cooking parameter, such that the user knows when the finalized command would result in the desired modification and such that the user knows when to move load 4 back to cooking zone 5.

According to some non-limiting embodiments, user interface 7 may be configured to allow for setting step width ΔX for one or more cooking parameters and/or the predetermined scheme and/or the instructions to be executed and/or the cooking parameter to be modified and/or “approval” and “disapproval” in dependence of movement of load 4 away from cooking zone 5.

Clearly, changes may be made to induction cooking appliance 1 without, however, departing from the scope of the present invention.

According to the example embodiment shown, induction coils 6 have a circular shape. However, induction coils 6 could also have a different shape, such as elliptical, oval, rectangular, bifilar or the like.

Furthermore, according to the example embodiment shown, all induction coils 6 have the same shape. However, according to alternative embodiments, one or more induction coils 6 may have a shape different from the shape of the other induction coils 6. It is even possible that induction cooking hob 1 could have a first portion of one or more induction coils 6 having a first shape, a second portion of one or more induction coils 6 having a second shape different from the first shape and at least one further portion of one or more induction coils 6 having a third shape different from the first shape and the second shape.

### LIST OF REFERENCE SIGNS

1 Induction cooking hob
2 Hob panel
3 Support surface
4 Load
5 Cooking zone
6 Induction coils
7 User interface
8 Housing
9 Edge portion
10 Display unit
A First axis
B Second axis
5 D1 First direction
D2 Second direction
D3 Third direction

1. An induction cooking hob for the thermal treatment of food products, comprising:
a support surface for carrying a load on a cooking zone, the load holding a food product;
a plurality of induction coils arranged below the support surface, wherein one or more induction coils of said plurality of induction coils are associated to the cooking zone;
a load detection unit operatively connected to the plurality of induction coils configured to sense by means of the plurality of induction coils a presence of the load in a vicinity of said one or more induction coils; and
a control and power unit operatively connected to the plurality of induction coils and configured to selectively power the one or more induction coils so as to selectively generate an electromagnetic field for heating the load on the cooking zone;
wherein the load detection unit is configured to sense by means of the plurality of induction coils a first movement of the load away from the cooking zone and to send a start signal about the first movement of the load away from the cooking zone to the control and power unit;
wherein the control and power unit is configured to determine a command signal in dependence of the start signal about the first movement of the load away from the cooking zone and to execute the command signal; and
wherein the control and power unit is furthermore configured to continue to selectively power the one or more induction coils so as to maintain the cooking zone at an unvaried location.

2. The induction cooking hob according to claim 1, wherein the load detection unit is also configured to sense by means of the plurality of induction coils a second movement of the load (4) back to the cooking zone at said unvaried location and to send an end signal to the control and power unit; and
wherein the control and power unit is configured to define the command signal in dependence of the start signal and the end signal.

3. The induction cooking hob according to claim 2, wherein the control and power unit is configured to determine the command signal in dependence of an amount of time between moving the load away and back from the cooking zone at said unvaried location and/or an amount of time between the start signal and the end signal.

4. The induction cooking hob according to claim 3, wherein the control and power unit is configured to modify a desired command associated to the command signal according to a predetermined scheme after receiving the start signal and to end modification of the desired command after receiving the end signal so as to obtain a finalized command; and
wherein the command signal is indicative about the finalized command.

5. The induction cooking hob according to claim 4, wherein the command signal is indicative about a cooking parameter and the finalized command defines a new cooking parameter;
wherein the control and power unit is configured to control the one or more induction coils associated to the cooking zone in dependence of the new cooking parameter; and
wherein the predetermined scheme comprises a step width and the control and power unit is configured to modify the desired cooking parameter as a function of the step width and between the time of receiving the start signal and the end signal.

6. The induction cooking hob according to claim 5, wherein the cooking parameter is chosen from a desired power level, a cooking time or a desired cooking temperature of the load and/or the food product.

7. The induction cooking hob according to claim 5, further comprising a user interface configured to allow for setting the step width and/or the predetermined scheme.

8. The induction cooking hob according to claim 1, wherein the load detection unit is configured to detect by means of the plurality of induction coils a direction of the first movement of the load away from the unvaried cooking zone; and
wherein the command signal is dependent on the direction of the first movement.

9. The induction cooking hob according to claim 1, further comprising a user interface configured to allow for setting a type of the command signal.

10. The induction cooking hob according to claim 1, further comprising a display unit configured to indicate information associated to the command signal.

11. The induction cooking hob according to claim 1, further comprising a voice control user interface configured to interact with a user by means of audio signals;
wherein the voice control user interface is configured to communicate to the user an action to be taken by the induction cooking hob;
wherein the command signal is indicative about an approval or disapproval of the action to be taken by the induction cooking hob;
wherein the control and power unit is configured to control an execution of the action communicated to the user by the voice control user interface in dependence of the approval or disapproval of the action.

12. A method of operating the induction cooking hob according to claim 1, the method comprising the steps of:
powering the one or more induction coils associated to the cooking zone;
performing the first movement of moving the load away from the cooking zone;
sensing by means of the plurality of induction coils the first movement of the load away from the cooking zone;
sending the start signal about the first movement of the load away from the cooking zone to the control and power unit;
executing by means of the control and power unit the command signal determined in dependence of the start signal about the first movement of the load away from the cooking zone; and
newly placing the load onto the cooking zone, wherein said cooking zone remains at said unvaried location.

13. The method according to claim 12, further comprising the steps of:
detecting, during which a second movement of the load back to the cooking zone is detected; and
sending an end signal to the control and power unit;
wherein during the step of executing, the control and power unit executes the command signal, which is determined in dependence of the start signal and the end signal.

14. The method according to claim 13, further comprising a step of adjusting, during which the control and power unit determines the command signal in dependence of the time between moving the load away and back from the cooking zone at said unvaried location and/or the time between the start signal and the end signal.

15. The method according to claim 14, wherein during the step of adjusting, the control and power unit modifies a desired command, being indicative about a desired cooking parameter, associated to the command signal according to a predetermined scheme after receiving the start signal and to end modification of the desired command after receiving the end signal so as to obtain a finalized desired command, the finalized desired command being indicative about a new cooking parameter; and
wherein during the step of executing, the command signal executed by the control and power unit is indicative about the finalized desired command, and the control and power unit controls the one or more induction coils according to the new cooking parameter.

16. The induction cooking hob according to claim 1, further comprising a display unit configured to display an action to be taken by the induction cooking hob;
wherein the command signal is indicative about an approval or disapproval of the action to be taken by the induction cooking hob visually communicated to the user by means of the display unit;
wherein the control and power unit is configured to control an execution of the action visually communicated to the user by the display unit in dependence of the approval or disapproval of the action.

17. An induction cooking hob for thermally treating a food product, the induction cooking hob comprising:
a support surface configured to support a load thereon, said support surface extending along a first imaginary axis and a second imaginary axis, wherein said first imaginary axis is perpendicular to said second imaginary axis;
a plurality of induction coils disposed below the support surface, wherein a first induction coil of said plurality of induction coils is associated with a cooking zone, wherein said cooking zone is disposed at a first location relative to the support surface;
a load detection unit operatively connected to the plurality of induction coils, said load detection unit configured to sense a presence of the load in a vicinity of the first induction coil; and
a control and power unit operatively connected to the plurality of induction coils and configured to selectively power the first induction coil so as to selectively generate an electromagnetic field for heating the load,
wherein the load detection unit is configured to sense a first movement of the load away from the cooking zone and to send a start signal about the first movement to the control and power unit, and to sense a subsequent, second movement of the load back to the cooking zone and to send an end signal to the control and power unit, wherein said cooking zone remains at said first location during said first and second movements of the load, and
wherein the control and power unit is configured to determine a command signal based on an amount of time between the start signal and the end signal and a direction of said first movement, and subsequently execute said command signal.

18. The induction cooking hob according to claim 17, wherein when said direction of said first movement is parallel to said first imaginary axis, the command signal determined by the control and power unit is indicative of a cooking parameter comprising a desired power level, a desired cooking time, or a desired cooking temperature of the load

19. The induction cooking hob according to claim 18, further comprising a user interface configured to communicate to a user an action to be taken by the induction cooking hob, wherein when said direction of said first movement is parallel to said second imaginary axis, the command signal determined by the control and power unit is indicative of an approval or disapproval of the action to be taken by the induction cooking hob.

20. The induction cooking hob according to claim 19, wherein said action is communicated to a user via an audio signal.
